(19) United States
(12) Patent Application Publication
(10) Pub. No.: US 2003/0040854 A1
(43) Pub. Date: Feb. 27, 2003

(54) Data processing and validation

(76) Inventors: Craig S. Rendahl, Tucson, AZ (US); Kelley Bogart, Tucson, AZ (US); Jason Webster, Tucson, AZ (US)

Correspondence Address: MINTZ LEVIN COHN FERRIS GLOVSKY AND POPEO PC, 12010 SUNSET HILL ROAD, SUITE 900, RESTON, VA, 20190, US

(21) Appl. No.: 09/818,684

(22) Filed: Mar. 28, 2001

Related U.S. Application Data
(63) Continuation of application No. 09/634,659, filed on Aug. 8, 2000, now abandoned.
Application No. 09/634,659 is a continuation of application No. 09/474,131, filed on Dec. 29, 1999, now abandoned.
(60) Provisional application No. 60/114,554, filed on Dec. 31, 1998.
(60) Provisional application No. 60/114,568, filed on Dec. 31, 1998.

(51) Int. Cl. G06F 7/00

(52) U.S. Cl. 701/29; 701/33

(57) ABSTRACT

A data processing and validation system is used for data from remote sensing devices for vehicle emissions. The system transfers data including emissions data and vehicle images from a remote sensing unit to the data processing system. A user processes and validates the data based on vehicle images and other information gather by the remote sensing device. Data may then be converted into text form and loaded into a spreadsheet or database for viewing by a user. Vehicle images may be printed out along with emissions data for enforcement purposes. A variety of data processing forms may be generated to improve management of data processing and validation.

### RELATED APPLICATIONS

This application claims priority under 35 U.S.C. §119(e) to U.S. Provisional Patent Applications Serial Nos. 60/114,554 and 60/114,568, both of which were filed on Dec. 31, 1998.

### FIELD OF THE INVENTION

The present invention is directed to data processing and validation of data collected from sensing devices, and more particularly from devices for remotely detecting components of vehicle emissions.

### BACKGROUND OF THE INVENTION

Environmental pollution is a serious problem which is especially acute in urban areas. Motor vehicles, such as automobiles, are a considerable contributor to this pollution dilemma, especially those not equipped with anti-pollution devices, or with breaches in their structural integrity. Centralized systems to detect vehicle emissions at specific test locations are known. One such system, described in U.S. Pat. No. 5,729,452, senses the emission plume of a vehicle. If the vehicle emission fails, the diagnostic system prepares a repair report which identifies the cause of the failure. This system has the drawback that the system requires vehicles to be taken to the specific test location.

Systems for remotely sensing vehicle emissions (e.g., roadside) also are generally known. A conventional system for remotely sensing vehicle emissions includes a sensor for sensing the emission plume, and an image retrieval device, such as an automatic license plate reader to ascertain the identity of a vehicle of which the exhaust plume is being sensed. The identity of the vehicle is generally determined by viewing the license plate of the vehicle.

Automatic license plate readers may suffer from the problem of not obtaining a clear picture of a license plate of a vehicle being sensed. A license plate may be obscured by a trailer hitch or a trailer, or may be covered with dirt or snow. The license plate area may also be too dark to obtain a clear picture to read by the automatic license plate reader. If an automatic license plate reader is ineffective, sensed emissions data cannot be associated with a particular vehicle or type of vehicle. In areas where remote vehicle emissions test data is used to determine if a vehicle must report for a more comprehensive emissions test, failure to capture a vehicle license plate hinders the emissions control enforcement effort.

One such license plate reader is described in U.S. Pat. No. 5,515,042. In this system, an automatic license plate reader is mounted to a vehicle. When a speeding vehicle is encountered, the license plate reader, in conjunction with a global positioning system, produces a vehicle identifying image with the date, time, speed, and location superimposed on the image. This system, however, does not provide for data validation should the vehicle license plate be obscured from view.

U.S. Pat. No. 5,583,765 discloses a remote system for monitoring the weight and emissions of trucks. The system detects the emissions from an exhaust plume of a truck. A bar code located on the truck is scanned for identification purposes, and an image of the vehicle is used for visual verification. The system does not disclose using an automatic license plate reader, but rather requires a specialized bar code for each vehicle to be detected. This system also fails to provide for data validation should the license plate of the vehicle be obscured from view.

Another remote vehicle emission sensing device is disclosed in U.S. Pat. No. 5,719,396. A first and a second monitoring station are used to determine vehicle emissions. Two video cameras and an automatic license plate reader are used to insure vehicle identification. Video images in a display monitor may be used to verify that the license plate reader has correctly identified the license plate numbers.

Conventional data processing and validation systems also suffers from the drawback of failing to account for the wide variety of vehicle licenses plates which are currently in use. If specialized license plates are not read properly by an automatic license plate reader, vehicle emission statistics and/or law enforcement efforts may be skewed and the public may view this as an effort to target certain classes of vehicles.

These and other drawbacks of current vehicle emissions testing devices exist.

### SUMMARY OF THE INVENTION

An object of the various embodiments of the present invention is to overcome these and other drawbacks in existing devices.

Another object of one embodiment of the invention is to provide systems and methods for processing and reviewing data gathered from vehicle emissions by a remote sensing device.

Another object of an embodiment of the present invention is to provide systems and methods for comparing image data from a vehicle with an automatic license plate reader output taken from the vehicle to ensure that license plate data is correct.

Another object of an embodiment of the present invention is to provide systems and methods for matching license plate data with motor vehicle registration records, thereby obtaining more information about a vehicle owner.

Another object of an embodiment of the invention is to provide systems and methods for ensuring the accuracy of data gathered by a remote sensing device by checking remote sensing device components.

Another object of an embodiment of the invention is to monitor significant activity occurring around the location of the remote sensing device which may affect the gathered data.

Another object of an embodiment of the invention is to provide systems and methods for identifying patterns of problems in data gathered by a remote sensing device.

Another object of an embodiment of the invention is to provide systems and methods for gathering and processing data on vehicle emissions from a remote sensing device, wherein the data may be used for law enforcement.

Another object of an embodiment of the invention is to provide systems and methods for processing and reviewing data on vehicle emissions from a remote sensing device, wherein the chain of custody of the data is maintained to allow introduction of the data as evidence in a judicial proceeding.

These and other objects of the invention are accomplished according to various embodiments of the invention. Certain embodiments of the invention relate to a method for validating data from a remote sensing device. A plurality of records, each record containing vehicle data, may be received from a remote sensing device. The records may be validated and sent to a predetermined location. Validating records may comprise comparing image data of a vehicle license plate with license plate data from an automatic license plate reader. Data may also be reviewed to determine reliability and/or accuracy of the emissions data. A system for implementing this method is also provided.

Other embodiments of the invention relate to a method for validating information from a remote sensing device. The remote sensing device generates emissions data, image data and license plate data for a vehicle. The emissions data image data and license plate data are combined to form a record. A record is forwarded to a processing station, where the record is displayed, validated and forwarded to a predetermined location. A system for implementing this method is also provided.

These and other aspects of the various embodiments of the present invention shall become apparent from the accompanying drawings and detailed description thereof.

### BRIEF DESCRIPTION OF THE DRAWINGS

FIG. 1 is a flowchart of a method for data processing and validation of remotely sensed vehicle emissions data in accordance with an embodiment of the invention.

FIG. 2 is a flowchart of a method for collecting data from a remote sensing device, according to an embodiment of the invention.

FIG. 3a is a flow chart of the tag edit function according to one embodiment of the invention.

FIG. 3b depicts an example of a graphic user interface that illustrates various aspects of one embodiment of the data validation process of the invention.

FIG. 3c is a block diagram of a tag edit system.

FIG. 4 is a flowchart for a method of plate matching in accordance with an embodiment of the invention.

FIG. 5 is a flowchart of a method for data submission in accordance with an embodiment of the invention.

FIG. 6 is a flowchart of a method for data archival according to an embodiment of the invention.

FIG. 7 is a flowchart of a method for extracting data according to an embodiment of the invention.

FIG. 8 is a block diagram depicting some of the functions of the processing and management form generator according to an embodiment of the invention.

FIG. 9 is a block diagram of a data processing and validation system in accordance with an embodiment of the present invention.

FIG. 10 is a block diagram of a remote emissions sensing device in which the present invention may be employed.

### DETAILED DESCRIPTION OF THE PREFERRED EMBODIMENTS

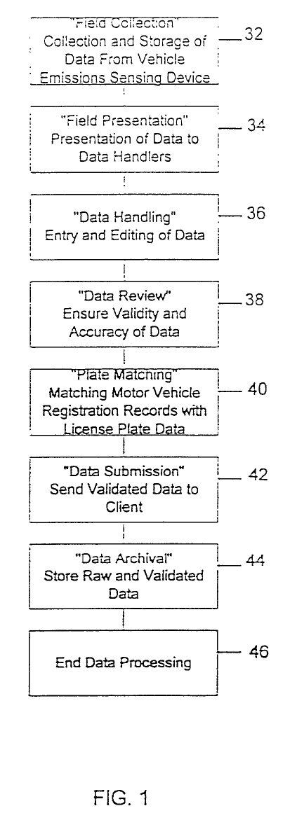

A description of steps which may be employed to accomplish data processing and validation is given in the context of FIG. 1. “Field Collection” occurs at step 32, where vehicle emission data, image data, license plate data or other data from a remote vehicle emission sensing device (“RSD”) is collected and preferably stored. “Field Presentation” may occur at step 34, where collected data is presented to data handlers. “Data Handling” may occur at step 36, and may include entering and editing data, as necessary. “Data Review,” may occur at step 38, is performed to ensure the accuracy of at least some of the data. At step 40, “Plate Matching” may match license plate data to records of registration data for motor vehicles. “Data Submission” occurs at step 42, where validated data may be sent to the appropriate client. “Data Archival” occurs at step 44, where raw data and validated data are stored for safekeeping and later retrieval. Data processing is terminated at step 46. Various combinations of one or more of these steps may be present in different embodiments of the present invention. A more detailed description of each of the steps of data processing is given below.

As illustrated in FIG. 1, collection and optional storage of data from an RSD occurs at step 32. An RSD obtains vehicle emission data. An RSD also may gather image data including an image of the license plate of a vehicle, license plate data which corresponds to a license plate number read by a human operator or by, an automatic license plate reader (ALPR), and other data such as engine temperature, ambient conditions, date, time, traffic data, speed and or acceleration data, and or calibration data. A variety of data relating to each vehicle as well as associated other data, such as calibration data, time data, speed and/or acceleration data, and/or data on ambient conditions may be combined to form a data record. A more detailed description of such a system is provided below.

Data is collected for loading into a data processing network in preparation for processing, validation, and review (steps 36 and 38). In one embodiment of the invention, data from a single RSD are collected and processed together. Data may be collected and processed at each RSD, or data may be collected at each RSD and transferred to a central data center to be processed at step 36. FIG. 1 illustrates, by way of example only, an embodiment of the present invention which collects data at one or more remote locations, transfers the data to a central data collection facility, and processes and validates the data at that central facility.

According to an embodiment of the invention, data may be transferred to a central data collection facility from one or more remote locations by telephone lines, cable lines, wireless transmission, computer modem, internet transmission, email, satellite transmissions on physical media such as magnetic disk, or by any other conventional data transmission means. In a preferred embodiment of the invention, data is received at a central data collection facility on rewritable optical storage disks. The data may be saved and/or backed up at the collection facility to allow for processing and validation without risking loss of the original data. Image data may be stored separately from emissions or other collected data, thereby helping to ensure privacy for vehicle owners. Data may be stored in compressed form, particularly image data, which lends itself to compressed storage.

Data to be processed may be imported from data storage into a data processing network, or may be imported directly from an RSD into a data processing network without storage, if desired. In one embodiment of the invention, data may be imported using a data importation program described in greater detail below.

Collected data may be presented to data handlers in step 34. According to an embodiment of the invention, data may be presented to data handlers via accessing a computer network. Data may be placed within the network. A data handler may access the network electronically, such as by the internet through an internet service provider, or from a processor, such as a personal computer, workstation, or similar device. Access to the network may be controlled through the use of passwords or other conventional security measures. Other methods of electronically accessing the network may also be used, such as through a closed network connection. According to an embodiment of the invention, a data handler may also download data from the network onto a storage medium of a computer for processing. Other known methods of accessing the data for processing may also be used.

Data Handling occurs at step 36, and may preferably include validating data at least by verifying license plate data based on image data, where the image data includes an image of the license plate of a vehicle and/or gives an indication of the vehicle make, model, year or type. In one embodiment of the invention, the data handler may enter license plate numbers based upon image data using a tag edit program (or “tag editor”). A tag editor may also be employed to verify license plate numbers generated by a human operator or by an optical character reader such as an ALPR. A disk operating system (DOS)-based tag editor, a tag editor that is compatible with a Windows® application, or a tag editor based upon another operating system may be used.

A tag editor may also be employed to code traffic that passes an RSD based on image data and/or other collected data. Coding may include identifying the type of vehicle (e.g., motorcycle, school bus, automobile, construction equipment, diesel, gasoline, etc.) for which data is taken by the RSD, identifying the type of license plate on a vehicle, excluding particular vehicles from a data sample based on vehicle type or license plate information, selecting particular classes of vehicles, etc. In an embodiment of the invention, information useful for performing traffic studies may be obtained and maintained in conjunction with emissions data. The tag edit program is described in greater detail below.

Data that has been processed may be reviewed at step 38. In an embodiment of the invention, processed data may be translated into a text file or suitable output files for viewing the results. Data translated into an appropriate form permits importation into spreadsheet programs. Contemporary examples of spreadsheet programs include QuattroPro®, Lotus®, and Excel®. Data may alternately be translated into an appropriate form and imported into a database. Contemporary database applications include Dbase®. Access®, and SAS®. Other suitable applications for viewing data may also be used.

Conversion of data into an appropriate form for spreadsheet or database applications allows a reviewer to ensure the quality of the data in a reliable, quick and efficient manner. According to a preferred embodiment of the invention, accuracy and/or validity checks are made on data and data records that do not meet predetermined quality assurance standards may be flagged, invalidated, labeled as suspect, or removed. Other forms of quality assurance may also be employed.

In addition, the data review step 38 may be employed to implement a variety of specifications, such as those mandated by State law, to ensure such things as data accuracy, random sampling, appropriate data selection, data validity, privacy and other types of activities which can be furthered by data manipulation.

Reviewed data may be matched with vehicle registration data at step 40, thereby providing information regarding the owner of a vehicle as well as the type of vehicle. According to an embodiment of the invention, license plate data may be matched with information in motor vehicle registration records. This information may include the name and address of a vehicle owner, thereby facilitating notification of the owner of the results of an emissions test on the vehicle.

Data may be submitted to a client or other entity in step 42. In an embodiment of the invention, image data of vehicles may be output as part of a warning or citation and then be employed by law enforcement agencies for law enforcement. In another embodiment, the entire database may be turned over to state agencies for the purpose of traffic and/or emissions studies. Data may be submitted on any appropriate media. Media may include electronic transmission, magnetic storage disks, optical storage disks, written reports, or other methods for communicating data.

To ensure later retrieval, data may be archived at step 44. According to an embodiment of the invention, various types of archived data may be stored. Data to be archived may include, but is not limited to, collected data, data edited by data handlers, data that has been reviewed for accuracy and/or validity, data that has been submitted, and other data. Archived data may be stored on magnetic or optical disks, or may be stored on a storage area of a processor. Other methods of storing data may also be used. Archived data is preferably stored using redundant data storage devices at different locations.

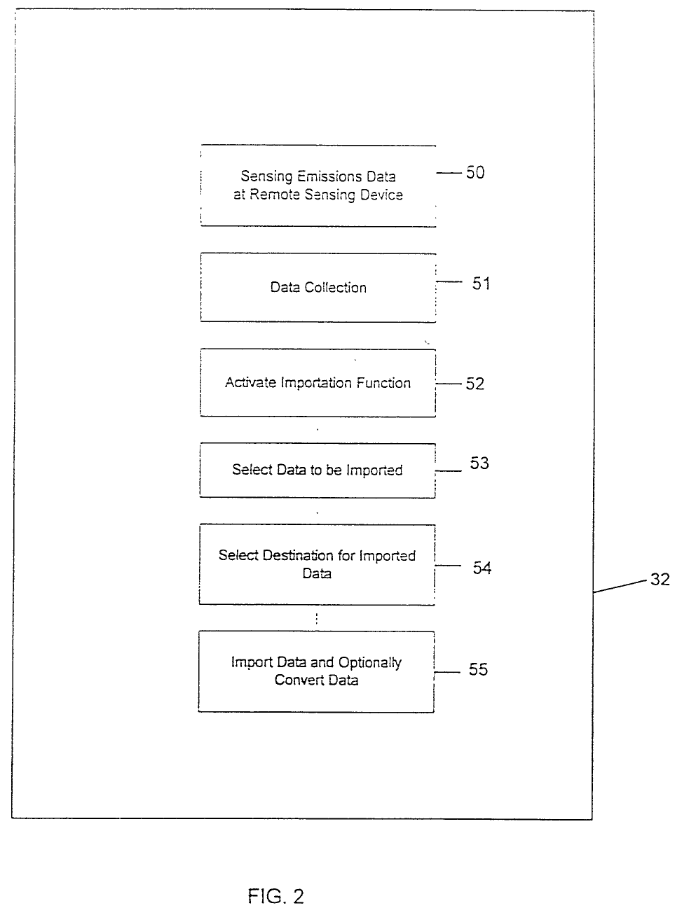

According to an embodiment of the invention, a data importation program may be used in connection with the data collection of step 32 of FIG. 1. FIG. 2 illustrates, by way of example only, an embodiment of a data importation program used in data collection. An RSD senses emissions from vehicles at step 50. At step 51, an RSD collects other data. Other data collected may include image data, emissions data, license plate data and other data. The data importation program is activated at activation step 52 and data to be imported is selected at step 53. A destination for the imported data is selected at step 54. According to an embodiment of the invention, a computer network may be selected as the destination for the imported data. Data is imported to the selected destination at step 55. According to an embodiment of the invention, the data importation step may also include the step of converting data into a more appropriate format for a particular computer network or software application.

Emissions data gathered by an RSD may be stored in a vehicle data file. A user may select which vehicle data file or files to convert and select a destination directory for the converted files. A destination directory may include any standard database or spreadsheet, depending on the user's preference. Thus, in an embodiment of the invention, original files and converted files may coexist. A user may activate the conversion program, thereby creating a text file from a vehicle data file.

Data importation may include compressing data files if data compression is necessary or desirable. For example, pixel files may be compressed by converting pixel data into Joint Photographic Experts Group (“JPEG”) formatted pictures. Files may be compressed to one/ninth of the files' original size. Other factors of compression may also be used. Such factors may depend on hardware configurations and limitations. If large scale central data processing is to be carried out, some data compression may be required.

In another embodiment of the invention, data importation may be used to conduct file maintenance procedures. File maintenance procedures may include copying files from a disk, and/or creating archive copies of a file, thereby allowing restoration of a file should problems later arise with that file. Also, virus scans and disk checking operations may be performed at this stage.

A data importation program may import data into a destination folder in a network. Such a network may contain a designated area for data files. In an embodiment of the invention, a data importation program determines if files to be imported already exist in a destination folder. If imported files already exist, a data importation program may import new files using a modified filename. This embodiment enables importation of data without overwriting previous data.

In an embodiment of the invention, data importation dates may be used to prioritize processing, e.g., first imported, first processed. Prioritizing data processing in this manner may allow for quicker return of results and reduce delay. This feature may be useful for time sensitive data, such as data destined for law enforcement or regulatory agencies.

According to an embodiment of the invention, data may be validated by inspecting the data. Inspecting data may comprise data handling, and data review. According to an embodiment of the invention, inspecting data comprises ensuring the accuracy of the data, and determining if data meets predetermined quality assurance criteria. Other methods of inspecting data may also be used.

Data handling, at step 36 (see FIG. 1), may be performed by entering license plate numbers of vehicles for which data has been taken. An emissions detection system may be coupled with a vehicle imaging device which records a image of at least a portion of a vehicle preferably including the license plate. The apparatus may optionally also include an ALPR which preferably enters into a data storage system the license plate number of the vehicle for each emission detection performed. An operator may use the tag edit function of the present invention to view the vehicle image data and/or each license plate entry in the system to ensure the accuracy of the identification of each vehicle and/or to correct invalid or incorrect entries. The tag edit function allows a user to enter and edit license plate numbers, as well as enter and edit various additional information relating to the vehicle for which vehicle emission data has been collected.

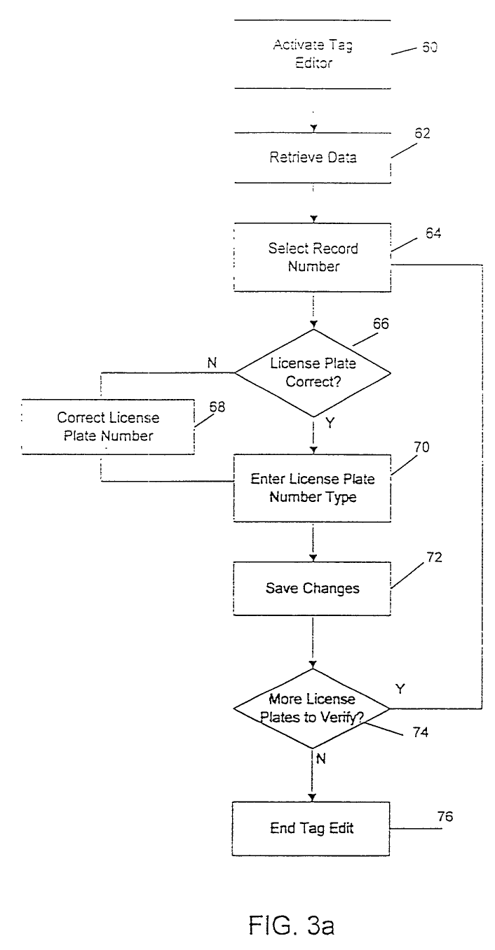

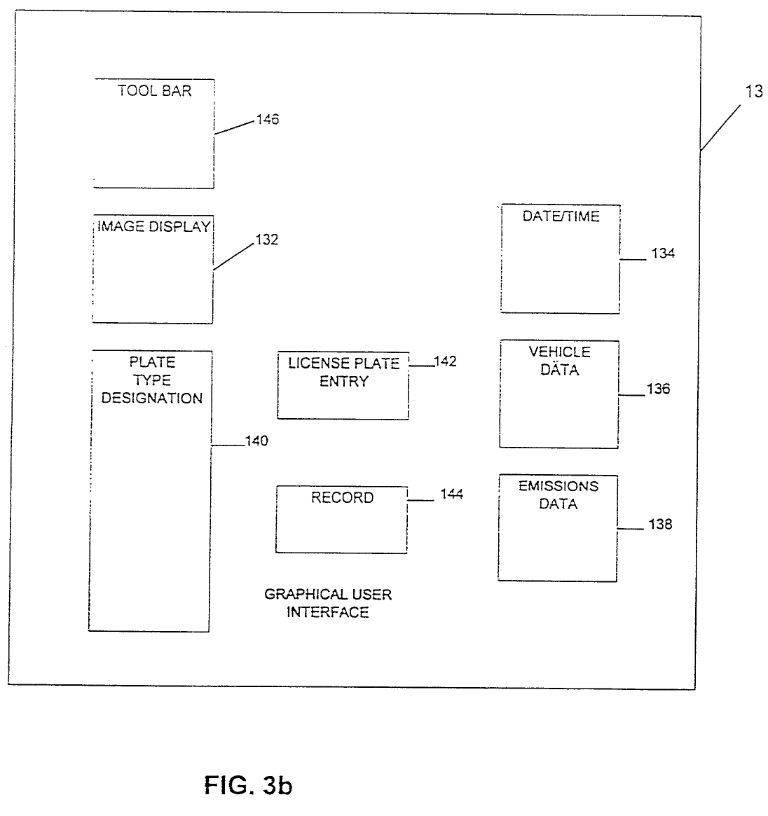

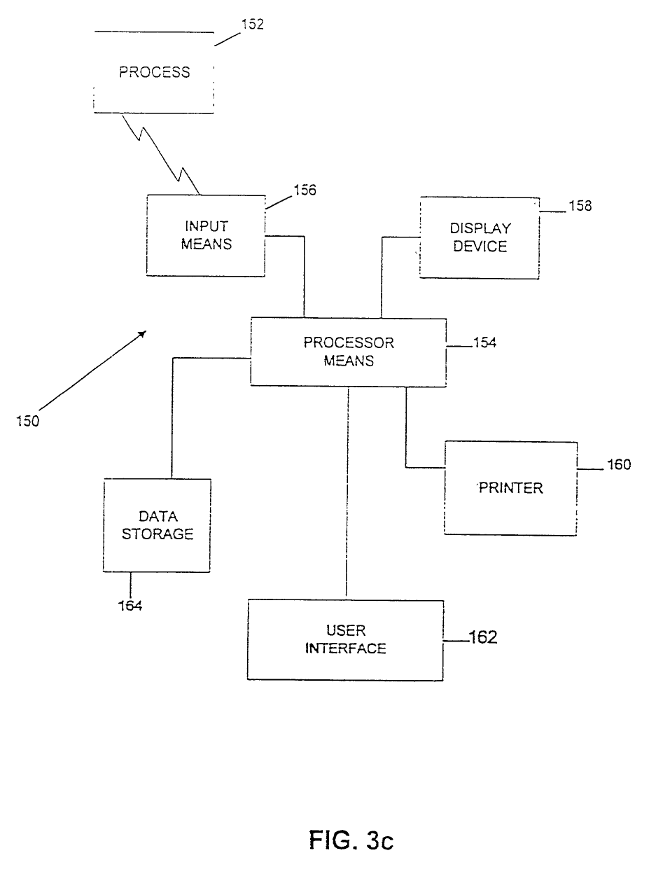

As illustrated by FIG. 3a, one embodiment of the tag editor of the present invention may involve activation of the tag editor function at activation step 60. Data to be edited may be retrieved from the appropriate files at step 62. A vehicle record number is then selected in step 64. The user may then either enter a license plate number or verify whether the license plate number already entered in the selected record by an ALPR is correct at step 66. In one embodiment of the invention, each set of vehicle emission data may be assigned a record number, thereby allowing easy identification of a particular entry. If a license plate number is incorrect, the correct license plate number may be entered into the system at step 68.

In another embodiment, vehicles may be categorized based on the various types of license plates. In this embodiment, at step 70 a license plate type may be selected from a set of predetermined categories. Categories may include out-of-state license plates, affinity license plates, government license plates, embassy plates, unreadable license plates, license plates hidden by obstructions, vehicles pulling trailers, or any other type of license plate or other desirable categorization of license plates which may be encountered at a particular detection location. Changes and/or additions made to the license plate record may be saved at step 72.

At step 74, a determination may be made of whether to continue editing license plate records. If a user elects to continue, a new record is selected as at step 64. A user may also choose to close the tag edit function at step 76.

In one embodiment of the invention, a conversion program may convert data into text form. Data may be converted into a format that may be read by conventional databases or spreadsheets. Vehicle images may also be extracted. In one embodiment of the invention, vehicle images are extracted from the data and posted into a document, such as a warning or citation, for law enforcement purposes. A more detailed description of various aspects of the tag edit function will now be given.

The functions of a tag editor of one embodiment of the invention may grouped in various categories for better understanding, and description. One category of functions may be described as Navigation functions, which include functions that enable navigation within the tag editor. Another category of functions may be described as License Plate Type functions, and may include functions that relate to identifying, validating, correcting and categorizing the license plate types. Another category of functions may be described as Vehicle Type functions. A Vehicle Type function may be used to identify and/or classify vehicles. A further category of functions may be identified as Help functions, which aid in performing other functions. A final category of functions are Database Manipulation functions which are high level functions that enable modification of various parameters of the tag editor database. Some functions may fall into more than one category. Functions may be accessed by activating an appropriate icon on a graphical user interface, or may be associated with a particular set of keystrokes. Other methods of accessing the functions may also be used.

Navigation Functions

Navigation functions allow navigation within the tag editor from record to record for display and/or editing purposes. A next record function allows movement to the next record, while a previous record function allows movement back to a previous record. A select record function allows the input of a specific record to be displayed. Navigation functions may also permit access to a record located in the middle of a group of records using a flag record function. This may be useful if an item of interest in a particular record has been identified. A user may also return to a particular record using a last record function. This Navigation function may be desirable if it is necessary to reedit or review the last record which was edited in a previous editing session. Additionally, if the active record does not need to be changed, or a user is unsure how to edit a particular record, the tag editor may move to the next record using a skip record function. The skip record function is also useful if a vehicle record does not meet predetermined validation criteria and it is thus desirable to skip the record without processing it. A final Navigation function is associated with an accept record verification function. More specifically, once a record has been determined to be acceptable for entry into the database of processed records, it may be accepted using an accept record function. Other Navigation functions may also be included in the tag editor of the invention for specific applications.

Verification Functions

Verification functions allow verification of the information displayed in a record, input of additional information which is not present in the record or modification of incorrect data in the record. The accept record function permits the record to be included in a database of processed records when it is determined that the data in the record is acceptable. The view/edit function allows verification of results from an ALPR by comparison with an image of the vehicle license plate. A modify license number function permits the license plate number associated with the record to be changed if the results from the ALPR are determined to be incorrect or incomplete.

A further verification function in the exclude record function allots a particular record to be excluded from the database of processed records. This function may also include a series of designations indicating the reason that a particular record was excluded.

Another verification function is the emissions data verification function which employs predetermined criteria to ensure that reliable emissions data have been obtained for a particular vehicle. An indication may be given that the emissions data is unreliable for any number of reasons including insufficient emissions plume, calibration errors, a reading which falls outside a predetermined acceptable range, improper alignment of optical components or any other applicable reason. This function alerts the user that the data is considered unreliable and prompts the user to exclude the record from processing.

Vehicle data present in a record may include the speed and acceleration of a vehicle. A vehicle traveling too fast or accelerating at a high rate may result in an unreliable emissions reading. In another embodiment of the invention, vehicle data displays whether the vehicle engine had just been started when the emissions test was performed. Emissions testing may be unreliable when the vehicle engine is not operating at its standard operating temperature, i.e., before the engine is fully warmed-up. Emissions data may be verified by a user of the system based on this type of vehicle data.

Emissions data present in a record may include data on various components of interest of a vehicle emission including the concentration, identity and an indication of whether the concentration exceeds predetermined limits. Components of interest may include carbon dioxide (CO₂), carbon monoxide (CO), hydrocarbons (HC), and nitrogen oxides (NOₓ) as well as other materials, depending primarily on the type of vehicle engine and the type of pollutants emitted by the engine. Emissions data may be verified by checking to see if inordinately high or low concentrations for one or more components has been registered by the RSD.

The components displayed may depend on the requirements of a user. For example, a state law may limit the amount of NOₓ that may be emitted from a vehicle. Emissions data may then display the amount of NOₓ emitted from a vehicle. The concentrations of other components may also be displayed for various purposes including determination of other emissions violations, determination of the reliability of the data and determination of the vehicle operating temperature. Record selection can be performed using any or all of this data. For example, it is possible to select only vehicles which have violated emissions standards for further processing if the data is being used for law enforcement purposes. Other Verification functions may also be included in the tag editor of the present invention.

License Plate Type Functions

License Plate Type functions allow identification and categorization of vehicles based on a variety of license plate types and/or categories of license plate data. One such function may allow the type of license plate of a vehicle to be identified. In one example, a vehicle may be identified as having no license plate, an unreadable license plate, an obscured license plate, a special license plate, and or an out-of-state license plate. Such designations may be used in subsequent data processing steps to provide statistical analysis, issue warnings or citations, target specific groups of vehicles for study or exclude certain records from further processing.

Other designations of license plate type include federal or state government vehicle and environmental license plates, i.e., electric, hybrid-electric, or natural gas powdered vehicles. In some jurisdictions, certain vehicles, such as government vehicles or environmental vehicles, may be exempt from emissions standards. This function may prevent these vehicles from inadvertently being issued a citation and/or being included in a statistical analysis of data.

Identifying license plate types may be useful beyond emission sensing. In one example, authorities may be alerted that vehicles with no license plates are on the roads. Additionally, identifying license plate types may allow for surveys of such items as the percentage of out-of-state vehicles or the types of vehicles using a particular road. Other types of information may also be provided based on designation of license plate types.

As illustrated in FIG. 3b, a user may view image display 132 and determine what license plate type should be designated for each license plate record. Typically this will be done by selecting from a list of predetermined license plate categories presented in a pull down menu or a similar user interface. An “Unreadable” license plate type may be designated when a license plate is unreadable. In a preferred embodiment, a dialog box appears when an “Unreadable” type license plate is designated. Additional designations may be presented in this dialog box to allow an operator to clarify why a license plate is unreadable. These additional designations may include an indication that a trailer hitch is obstructing the license plate, an indication that another object is obstructing the view of the license plate, an indication that a license plate is covered by mud or snow, an indication that the view of a license plate is dark, blurry, or glared, or an indication that at least part of the license plate was out of view. A variety of designations may be used with the system. These designations may be used to improve upon data gathering techniques by suggesting that adjustments are required to reduce the number of unreadable license plates.

An “Out-of-State” license plate type designation may be used when a vehicle has a license plate that is not issued by a predetermined state. In one embodiment, this license plate type only applies only to cars and light trucks since, in many states, other types of vehicles are subject to different emissions regulations. An operator may activate a “Help” function to obtain the correct state abbreviation, thereby indicating in which state the vehicle is licensed. This type of data is useful for either excluding out of state vehicles from law enforcement activities in a particular state or perhaps enforcing personal property and/or vehicle tax and inspection laws.

If a trailer is pictured in image display 132 (FIG. 3b), a user may designate a license plate type as a “trailer” type. This designation may assume that a vehicle and a trailer are owned by the same person. In one embodiment of the invention, an operator may use the designation for a trailer license plate as a way to exclude the record from the database due to a lack of confidence about emissions readings for vehicles towing trailers. When making this designation, a user may indicate that cars and trucks being towed are also considered trailers. In one embodiment, semi-trailers may have a separate designation, and would not be considered a “trailer” type license plate.

“Special plates” type license plates may be designated by a user for unusual plates. Unusual plates may include affinity license plates (i.e. license plates with names or symbols of colleges or universities), dealer plates, license plates with a symbol identifying the driver as disabled, environmental-type license plates, or license plates for vehicles owned by the Federal, State, or Local Government, embassies or the Military. In another embodiment of the invention, special plates may include temporary plates (plates associated with a recently purchased vehicle), and veteran plates. Veteran plates may, for example, have markings indicating various military affiliations. Other License Plate Type functions may also be included in the tag editor of the present invention.

Vehicle Type Functions

Vehicle Type functions allow the identification and categorization of various types of vehicles. One Vehicle Type function may involve indicating that a vehicle is a motorcycle. Additional functions may indicate that a vehicle is a large vehicle, such as a construction vehicle, a tractor trailer, or a school bus, or that a vehicle is towing a trailer. Another function permits a vehicle to be identified as an environmental vehicle.

Vehicle Type functions permit designation of certain vehicle types to serve as a basis for not issuing a warning or citation. It may be undesirable, for example, to issue citations to environmental vehicles, or to school buses. Designation of vehicle types may also allow information about various vehicles to be tabulated. In one example, emissions data of vehicles designated as semi trucks may be gathered. This information may then be used by regulatory agencies and the like to determine if emissions standards are necessary for that particular type of vehicle. Non-emissions information may also be gathered. Identifying vehicle types may allow for surveys of such items as the percentage of a certain type of vehicles using a particular road.

An operator may also designate a license plate as a “No Vehicle” type. This may occur when, for example, construction equipment (i.e. bulldozers, etc.), bicycles, or pedestrians are pictured in image display 132 (FIG. 3b). Motorcycles, licensed mopeds, and the like may be designated as “Motorcycle” type license plates. These designations are typically employed to exclude certain records from the processed database.

The present invention allows a user to differentiate between and designate vehicles that are subject to emissions testing and vehicles which are not subject to emissions testing. For example, certain vehicles with gross vehicle weight ratings greater than a predetermined weight, such as semi-tractors and trailers, school buses, and the like may not be subject to emissions testing. An image display in a graphic user interface may allow a user to appropriately determine which vehicle data records to edit, and which vehicles are not subject to emissions testing and therefore can be excluded from the database. Other Vehicle Type functions may also be included in the tag editor of the present invention.

Help Functions

A Help Function may inform a user how to perform various functions associated with the tag editor. One function may allow instructions regarding how to operate a specific function to be displayed. By way of illustration only, the function may be activated, thereby allowing a specific function for which help is desired to be indicated. Instructions regarding the function indicated may be presented. Thus, instructions for a function may be received without accessing the particular function.

Another function may allow receipt of instructions regarding the operation of a function being used at the time. Thus, by way of illustration only, a specific function to be used is activated. A Help function may then be activated to provide instructions regarding the previously activated function. Thus, a user may receive instructions for a particular function.

A Help function may provide assistance to an operator in navigating the tag edit system, or any other useful information about the system and its functions that may be needed to operate the system and take full advantage of its capabilities. Other Help functions may be included in the tag editor of the present invention.

Database Manipulation Functions

Database manipulation functions are high level functions which allow the database architect to modify the various other functions or to add, remove or alter designations or categories associated with other functions. For example, new license plate types can be added, different emissions data validation criteria can be inputted or vehicle types may be altered. These functions permit customization of the database to specific situations in which the database will be employed.

After activating the tag edit function, a user may locate the directory containing the data to be edited. In one embodiment of the invention, the operator locates a JAZ® drive, as developed by Iomega®, and the desired director of data. In another embodiment, a user may locate an appropriate network area to access the desired data. Other conventional methods of accessing data for the tag edit function may also be used.

A user may perform tag editing by entering license plate numbers of vehicles from photographs of such license plates taken by an RSD unit. Alternatively, a user may simply verify a license plate number assigned to a photograph of the license plate by an optical character reader and edit the number, as necessary. Various aspects of a license plate record may be displayed to allow the user to manipulate a variety of information contained in the record. A user may be presented with emissions data, vehicle speed, an image of a vehicle, vehicle acceleration information, dates, and times of measurements, etc. In one embodiment, as illustrated in FIG. 3b, a user may be presented with a graphic user interface 130 for entering license plate numbers and other relevant data. Graphic user interface 130 may contain an image display 132 and various portions of a license plate record, thereby allowing an operator to manipulate the information contained in the record. Graphic user interface 130 may also display date/time information 134, such as the date and time when the vehicle passed the RSD unit. Vehicle data 136 and emissions data 148 may also be displayed to a user.

License plate entry 142 may capture a license plate number by use of an ALPR provided with, for example, an optical character recognition device. The license plate number of the vehicle may be displayed. If a license plate number is incorrect, an operator may edit the license plate number based on image display 132. Editing may occur by comparing image display 132 with a license plate number displayed in license plate entry 142. License plate entry 142 may also include an icon to confirm, and/or save, all changes made regarding license plate entry 142. Optionally, the user may also designate a plate type 140 based on the license plate in image display 132. In one preferred embodiment, an image display 132 may be of the rear of a vehicle, to allow an operator to view the rear license plate of the vehicle. Tool bar 146 allows a user to save or print various data displayed on graphic user interface 140. Other standard types of user functions may also be included in tool bar 146, as desired.

A graphic user interface 130 may include record data 144, which may indicate the record number for a particular license plate record, as well as the total number of records in a particular file or directory. Record data 144 may allow a user to quit editing in the middle of a data file and begin again in the place where the user left off or may be used in a variety of data analysis functions as explained below.

A user may adjust the image display in the graphic user interface. In one embodiment of the invention, a user may be able to double an image size, or halve an image size. A zoom function may be provided which allows a user to zoom-in or zoom-out on an image by a desired factor to aid in the identification of a vehicle or the recognition of a license plate number.

FIG. 3c is a block diagram of a tag edit system 250 of one embodiment of the invention. An RSD 152 gathers vehicle emissions data. Such data may include a variety of different types of data such as machine readable code, textural data and digital image data. Data is sent to a processor means 154 via an input means 156. The function of input means 156 is to transfer data obtained by a remote vehicle emissions detector to a processing means 154 for data processing. In one embodiment of the invention wherein the emissions detection is performed at a location remote from the data processing location, input means 156 may include an optical storage disk or a magnetic storage disk. In another embodiment of the invention wherein direct connection from the device to the processor means 154 is desired, fiber optic cables may allow direct input of data from an RSD 152 to processor means 154. Other conventional input means 156 may be used.

A user may process data and enter various information using user interface 162. User interface 162 may include a particular screen display or set of screen displays and a keyboard, touch pad, or mouse, for example. Other user interface means may also be used such as light pens, touch screens, handwriting readers, etc. Data may be stored in data storage 84. Storage of data may occur at any time during the editing process. Data may be viewed by a user on a display device 158, or by printing data on printer 160. Other conventional means for viewing data may also be used.

Data Processing and Validation

As shown in FIG. 1, “Data Review” occurs at step 38. Data review may comprise checking data to ensure validity or accuracy. According to one embodiment, accuracy checks may be performed on all emission data to ensure that predetermined quality assurance levels are met. Data that does not meet the predetermined quality assurance levels may be flagged or removed. Data may be imported into a database, such as Microsoft Access®, to allow consistent review and manipulation of data. Other suitable methods of reviewing data may also be used.

In a preferred embodiment of the invention, only validated data is output to a user. In one embodiment, an RSD contains diagnostic equipment to assure that vehicle emissions data meets predetermined quality assurance criteria. In another embodiment, RSD calibration data may be employed to validate data. Data may then also be reviewed to ensure that a certain minimum amount of reliable data is present. For example, if ambient conditions change prior to acquisition of certain data, such data can be labeled invalid. Alternatively, a review of data collected in a specific time frame may reveal unreliable data based on certain criteria which can be applied to ensure that the data collection apparatus is functioning properly at all times. Invalid data may be output for diagnostic purposes.

In order to ensure the accuracy of RSD readings, an RSD may be initially calibrated against known concentrations of CO, CO₂, HC and NOₓ (Noₓ refers to one or more compounds including at least NO and NO₂), and/or under known atmospheric conditions. When there is no vehicle emission in the path, such as during calibration, the detector array produces an electrical signal. However, if one or more of CO, CO₂, HC, NOₓ, or other gas is present in the vehicle emission plume, it will absorb a portion of the radiant energy having certain characteristic wavelengths indicative of each species. Thus, an absorption electrical signal is generated by the detector array. The electrical signals produced by the detector array may be responsive to radiant energy of each characteristic wavelength and are proportional to the concentration of each detected species of the vehicle's emission.

Emission results are obtained by computing the ratios of one or more of the NOₓ, CO, CO₂, and HC voltages (I) to reference voltages (I₀) and rescaling these arbitrary units into calibrated NOₓ, CO, CO₂, HC and H₂O values with the use of calibration curves determined in a laboratory utilizing special flow cells fed with controlled mixtures of known concentrations of NOₓ, CO, CO₂, HC and H₂O. Computation may be done by a computer to obtain the concentrations of the various components of the emission.

In calculating concentrations of the various components of the exhaust gas, a computer may employ an algorithm which is a function of correction factors assigned to specific detectors in a detector array. A detector's correction factor is based on a detector's electrical properties, such as the responsivity, noise, detectivity, and time constant. However, these parameters may vary as conditions change, thereby influencing the value of a detector's correction factor. Correction factors will normally vary during a daily test cycle. Correction factors may be affected by optical path length, a change in background CO₂ and detector drift due to temperature and other conditions. However, if the testing path length is changed or the system realigned, then a new calibration may be performed in order to update correction factors. Alternatively, if the detector voltages drift due to temperature changes or changes in background CO₂, an alarm may indicate the need to perform a mandatory calibration.

Detectors may be calibrated by exposing one or more detectors to light from a light source. This step may be performed by directing the beam of light to the detector through a sample gas of known concentration and then a light filter, or this step may be performed by any other method which is well-known in the art. Once the beam of radiation encounters a detector, a measurement of the detector's response to the radiation is performed. A detector's response to the radiation may be indicative of certain parameters of the detector. These parameters, which will be discussed below, determine the detector's overall performance.

In order to calculate a correction factor for each detector, a comparison may be performed between predetermined reference responses to known concentrations of a particular emission component and a detector's measured response during the calibration process. The reference responses for components generally found within a vehicle's emission have been previously determined in laboratory experiments.

A detector's correction factor may be calculated by determining a factor which normalizes the present detector's response based on the reference response. Typically, several reference gas samples are detected during calibration in order to insure an accurate calculation of the correction factor. Based on these samples, a system may graph data and calculate a correction factor which most accurately compensates for a particular detector's response in comparison to the expected reference response. The correction factor may be calculated to be an integer, a slope of a line, if the detector response curve is linear, or as an algebraic function for non-linear detector responses.

Once a correction factor has been determined for an initial detector, the entire process is repeated for each detector, to determine correction factors for each of the system's remaining detectors. Furthermore, the method of attaining the correction factors may be repeated for each detector a plurally of times under different conditions to ensure the reliability of such correction factors.

Some embodiments of the invention may implement an algorithm to ensure that emission data is collected while the RSD is properly calibrated. The algorithm may be used to verify that certain detector signals are within an expected range for a properly calibrated device. For example, an algorithm may be used to compare the detector signals from a reference detector channel and a CO₂ detector channel. The algorithm may verify that the ratio of these detector signals remains constant within a predetermined range. If the ratio falls outside the predetermined range, the algorithm may cause a signal indicating an “un-calibrated” condition and enable the RSD to implement appropriate procedures, such as flagging the data collected, implementing re-calibration procedures, or other remedial procedures. The output of one or more of the detector channels may be used for the ratio. For example, the CO detector channel output may be part of the ratio. In one embodiment, data for each component or all components may be labeled invalid unless at least 10 of 50 plume sample deflections for CO₂ are between −0.25 and 12; at least 10 of 50 plume sample deflections for CO are greater than −0.25; and/or at least 5 of 50 sample deflections for one or more hydrocarbons are greater than −0.05.

Other embodiments include algorithms to verify that system optical components are in proper alignment. For example, embodiments of the invention may include an algorithm that recalls stored values that indicate a range of detector output voltages that indicate that the device is in alignment. The algorithm may verify that these predetermined voltage levels are achieved before an indication of proper alignment is indicated. For example, a “leveled” or aligned voltage reference channel value of 5.5 volts may be set as the predetermined alignment value. In some embodiments, a range of acceptable aligned voltage readings may be within ±0.3 volts of the predetermined (5.5 volt) level. Alternatively, a reference voltage level of between four (4) and 9.5 volts may be required before the RSD is indicated as properly aligned.

In another embodiment of the invention, data may be flagged to distinguish validated data from other data. Data may also be flanged as valid, invalid, or suspect. An RSD may require a minimum amount of vehicle emission plume for components to be measured. If an insufficient emission plume occurs, the resulting data may be designated as invalid or suspect or may be separately designated as not having enough emissions to perform the measurements and thereby create vehicle emission data. To sufficiently establish a slope (target emission/CO₂) from a plume, it is generally desirable to have a predetermined number of measurements over a predetermined interval of time. Overall plume strength can be determined by observing the amount of CO₂ in an exhaust plume. This measure of strength is possible because CO₂ is the most plentiful of all exhaust gases. If a plume deteriorates in less than a desired amount of time, for example, measurements for that plume may be labelled invalid. To make this determination, the total number of measurements may be divided into two or more duty-cycles of half (or some other faction) of the predetermined interval (e.g., for a half second interval two duty cycles of one quarter second each). The CO₂ measurements in the second duty cycle may then be monitored to determine whether there are a sufficient number of measurements above a predetermined level in that cycle for a sufficient plume.

One embodiment of the invention implements the following algorithm to determine if sufficient exhaust plume is present. The algorithm finds the “cleanest” air, either in the period just before or just after the detected presence of a vehicle, and compares the CO₂ detector channel readings for that “clean” air with the CO₂ values for the “dirtiest” air. As described herein “clean” and “dirty” refer to the relative absorption detector signal strengths for CO₂. The algorithm then verifies that a certain number of CO₂ detector readings exceed a predetermined CO₂ threshold before the exhaust plume is considered sufficient. For example, the algorithm may verify that eight (8) readings of greater than 0.5% CO₂ occurred in the first 250 ms and four (4) readings above 0.2% CO₂ occurred in the last 250 ms of a selected 500 ms duty cycle. Some embodiments of the invention enable the number of readings, percent concentrations, and/or data interval to be changed according to user input. For example, an RSD set up in an area of relatively fast moving vehicles may set the sufficient plume algorithm to verify that five (5) readings of 0.4% CO₂ occur within the first 250 ms of a 500 ms duty cycle, and readings in the second 250 ms are not checked because, for fast moving vehicles, most of the plume will have dissipated by then. Another sufficient plume algorithm may be to simply verify that at least five (5) readings of 0.2%-0.5% CO₂ occur sometime in a 500 ms data interval. Alternatively, a sufficient plume algorithm may take a sum of CO, CO₂ and HC (e.g., as propane) detector readings and verify that it exceeds a predetermined amount a predetermined number of times. Such an algorithm does not bias against measuring a plume for any vehicle regardless of its pollutant emissions.

According to an embodiment of the invention, a best fit (or other) curve plotting algorithm may be applied to plot the measurements on a graph with the X coordinate being the CO₂ measurement and the Y coordinate being the measurement for another emission of interest, such as CO, HC or NOₓ for example.

Another step in the plume validation may include performing a statistical analysis to determine statistical outliers. According to one embodiment, if an individual measurement for the emission being plotted (on the Y-axis) is more than a predetermined amount of percentage away from the best fit line (or another curve), that measurement may be discarded. For example, if the Y-axis value of a measured data point is more than 10% above (or below) a best fit line, that measurement may be discarded. Additionally or alternatively, a measurement may be discarded if it is greater than a predetermined maximum value. For example, the maximum value may be established as the lesser of 10% or the ratio of the maximum digitizer noise to the largest measurement in the group, or some other value. In some embodiments other algorithms may be provided to exclude inordinately high or low data readings. For example, data may be excluded based upon raw detector values for various emission constituents. One embodiment of such an algorithm may exclude data for a CO detector reading of less than −1% or greater than 21%, HC detector readings of less than −1000 ppm or greater than 40,000 ppm, and/or NO detector readings of less than −700 ppm or greater than 7000 ppm. Data values beyond these or other predetermined ranges are considered meaningless and are processed accordingly. The algorithm may be tailored to respond differently for the various outlying values. For example, if the CO reading is out of range, all of the recorded data channels (e.g., CO₂, HC, CO, NOₓ etc.) may be recorded as invalid, or otherwise discarded. Alternatively, if the HC reading is out of range only the HC data may be recorded as invalid, or otherwise discarded. Other responses are also possible.

Other embodiments include algorithms to check the apparent noise on the slope of the ratio of the various emissions constituents. For example, a error on the CO/CO₂ slope equivalent to ±20% for %CO greater than 1.0, and a slope of ±0.2% for %CO less than 1.0; an error on the slope of HC, CO₂ equivalent to ±20% for HC greater than 2500 ppm or equivalent to 500 ppm for HC less than 2500 ppm or an error on the NO CO2 slope equivalent to ±20% for NO greater than 1500 ppm or equivalent to 300 ppm for NO less than 1500 ppm, may be a reason to determine a reading is invalid or should be discarded.

According to one aspect of the invention, rather than simply invalidating or marking such a plume as suspect, a further step may be performed. That step involves determining if at least a second source of emissions may be present. The existence of a second source (if not identified as such) may cause an existing system to invalidate or flag as suspect a particular plume. According to this aspect of the present invention, the existence of a second source of emissions (e.g. from another vehicle or nearby building) may be determined. Other criterion for valid, suspect, and invalid data may also be used. One embodiment may implement an algorithm to verify that the ratio of measured pollutant to CO₂ must be constant for the source of emissions to be considered singular and valid. Other embodiments may evaluate whether a second peak in the detector reading of a pollutant (e.g., HC) is apparent for a single peak in a CO₂ detector reading. That second peak may be indicative of a second source of emissions. Other algorithms are possible.

A flag may also indicate that certain critical data is missing or that certain data has been determined to be unreliable. According to an embodiment of the invention, the speed and acceleration of a vehicle are recorded. Flags may be used to indicate if speed and acceleration data are suspect, or not within predetermined ranges. For example, speed data greater than 100 mph or less than 5 mpg and acceleration data greater than 14 mph/s or less than −13 mph/s may be considered invalid. Alternatively, sad values greater than 75 mph or less than 0 mph may be flagged. Some embodiments of the invention may include an algorithm to determine if the proper sequence of speed and acceleration data recording is achieved. For example, in an embodiment of the RSD using light detectors to measure the speed acceleration data, the data may be considered valid if at least two blocks and unblocks of the time buffer occur, all blocks occur before the unblocks on each sensor, and the number of blocks equal the number of unblocks for each sensor. Other algorithms are possible.

According to an embodiment, emission data may not achieve the proper purpose if a car is idling, driving below a predetermined speed, or sharply accelerating or decelerating. For example, a jurisdiction may wish to penalize vehicles that emit pollutants over a certain level. If the RSD records a high pollutant level (e.g., HC or CO) the speed/acceleration data should also be checked before any citation is issued. This is because an otherwise compliant vehicle may record rush HC values when decelerating or high CO values when accelerating and a citation should not be issued until it can be verified that the vehicle unacceptably pollutes under normal engine load. Thus, embodiments of the invention include algorithms to perform such checks. Some embodiments include algorithms to measure the engine load, as a function of road slope, speed and accelerations in order to give a more accurate indication of engine operation state.

Flags may also be used to indicate the status of license plate data. Other methods of designating data as being in a particular category may also be used.

Data reliability may also be verified during the data validation process. For example, data including aberrant readings may be discarded as unreliable. Alternatively, poor image data, the vehicle engine not being sufficiently warmed up or an atmospheric disturbance caused by wind, dust, smoke or pollen may result in unreliable data. For example, some embodiments may include an algorithm to determine if too much road dust or other particulate matter is present. Such algorithms may, for example, look at each 10 ms data point to see if the reference voltage has moved farther away from a predetermined average value, in which case the data may be invalid or otherwise discarded as containing too much particulate matter. Other algorithms exist to handle optically opaque exhaust plumes, such as those from diesel vehicles.

Data Processing

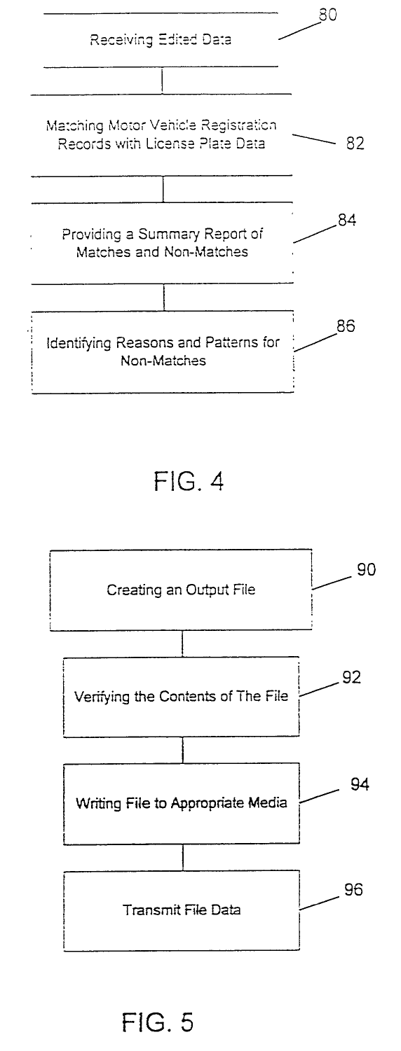

As illustrated in the flowchart of FIG. 1, “Plate Matching” is preferably initiated in step 40, since it may be undesirable to carry out plate matching at an earlier state, because that may involve unnecessary plate matching operations for invalid or suspect data. Data which has been edited may be received as shown in FIG. 4 at step 80. The data may be matched with various information about a vehicle. According to an embodiment of the invention, license plate data may be matched with motor vehicle registration records which may be obtained from a State department of motor vehicles. Other information, such as standard emission data for a particular vehicle type, may also be matched with data. This is shown at step 82.

At step 84, a summary report is provided. According to an embodiment of the invention, a summary report of matches and non-matches between license plate data and motor vehicle registration records may be provided. Reasons and patterns for non-matches may be identified in step 86. According to an embodiment of the invention, reasons and patterns for non-matches may be identified based on summary reports.

As noted previously in regard to FIG. 1, step 42 involves sending data to clients. Data may be sent by a variety of methods, including electronically, such as via an internet connection, physically, such as on a paper copy or a storage medium, such as a magnetic or optical computer disk, or other methods. FIG. 5 illustrates a flowchart for sending processed data to a client according to an embodiment of the invention. At step 90, an output file or files is created. The file may be created to meet the formatting specifications of the client. Thus, according to an embodiment of the invention, an output file may be formatted to allow the file to displayed on a computer using a Windows® program. Other formats may also be used.

The contents of a file(s) are verified at step 92. According to an embodiment of the invention, verification of a file may occur by viewing records randomly. At step 94, a file(s) is written onto the appropriate medium. According to an embodiment of the invention, a file may be written to an optical disk. According to another embodiment of the invention, a file may be written in an electronic format, and sent electronically, such as by e-mail or an internet connection. Other mediums or formats may also be used.

A file(s) is transmitted at step 96. Files may be transmitted electronically or physically, such as by sending paper copies of the data, or by sending a physical storage medium upon which the file(s) may be written. Other methods of transmitting a file(s) may also be used. According to an embodiment of the invention, appropriate personnel may be notified that a file(s) was made and sent. Notification may include indicating the contents of the file, the medium to which the file was written, and other appropriate information.

As noted previously in regards to FIG. 1, “Data Archival” occurs at step 44. According to an embodiment, once data processing and review has been performed, data may be moved to an archive area for permanent storage. In a preferred embodiment, data located in an archive area is saved to a mass storage device, such as a compact disk (CD), magnetic tapes, or other such storage device which does not form part of the data processing and validation network. Storage of data in this manner allows for data processing networks which require less memory, and therefore reduced network cost. Storage also increases protection of data from data loss due to network problems.

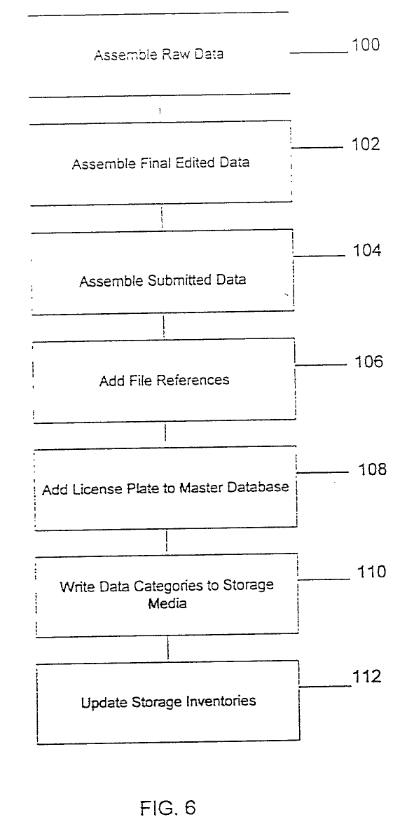

According to an embodiment of the invention, raw data and final edited data may be stored. Raw data may be data received directly from an RSD, while final edited data may comprise data that has been handled, e.g., processed, validated and/or reviewed. Stored data may be cross-referenced to allow for retrieval of appropriate data. Various data may be assembled in electronic form onto a specific storage medium or data may be in paper copy form and may be assembled in a storage area, such as a file room. Other manners of assembling data may also be used. FIG. 6 illustrates a method for archival of data according to an embodiment of the invention. Raw data is assembled at step 100. Raw data includes emissions data, image data, license plate data, and other data received from an RSD. Raw data may comprise any data which has not been handled or validated. Final edited data is assembled at step 102. Final edited data may include data which has been handled or validated. Other final data may also be assembled. Submitted data is assembled at step 104, and may include letters used to transmit documents, or other data.

File references for various assembled data are added at step 106. File references may be added to indexes to allow for cross-reference purposes. According to an embodiment of the invention, a file reference for raw data, final edited data, and submitted data may be added to individual indexes, with cross-references, where the indexes are located on a computer database. Other indexes may also be used.

License plate data associated with a particular RSD is added for cross-reference purposes at step 108. License plate data may also be associated with a date or time of test. According to an embodiment of the invention, license plate data associated with a remote sensing device, a date, and a time are added to a master database.

Various data is written to an appropriate storage medium at step 110. According to an embodiment of the invention, storage redundancy may be provided at a location remote from processing, thereby allowing data to be appropriately secured. An appropriate storage medium may comprise an optical storage disk, a magnetic storage disk or other storage medium.

At step 112, appropriate inventories or indexes, both on-site and off-site, are updated to account for new data storage. Updating storage inventories or indexes may include updating a database which indicates the storage of various data. Other updating may also be used.

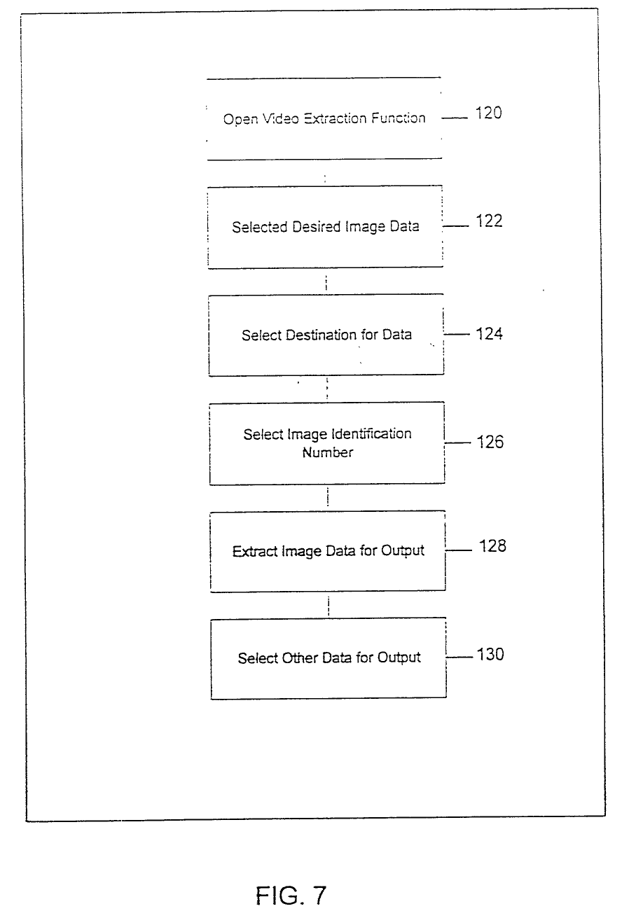

A user may elect to provide a customized data output. In an embodiment of the invention, selected image data may be used to paste a video image from a vehicle emissions test into a document (such as a summons or warning for law enforcement purposes). To accomplish this, a video extraction function is performed at step 120, as shown in FIG. 7. In a preferred embodiment, an individual video image may be extracted from a JPEG compressed video capture file. A user selects desired image data to be extracted at step 122, and selects a destination at step 124 for the extracted data. A user may also select an image identification number at step 126. Image identification numbers may correspond to vehicle sequence numbers e.g., the order in which vehicle records occur. Use of image identification numbers allows a user to avoid inadvertently extracting an incorrect image. A user extracts image data at extraction step 128. Other video extraction functions may also be used. In one embodiment, an image data extraction function may be included in archive files, such as compact disk archives, thereby allowing compact disks to be self-contained. This is indicated at step 130.

An advantage of the data processing and validation system is that it permits the production of a customized output depending upon the needs of a particular user of the system. For example, as mentioned above, a system can be used to generate warnings and/or citations for use by law enforcement agencies. A variety of other customized data outputs are possible as well. Another use for this function is to generate a statistical analysis of data based only on validated data records. Another variation permits the identification and notification of all vehicles which appear to have inoperative pollution control systems. Output may be selected based on license plate type to provide reports to government agencies regarding the emissions of vehicles in their vehicle fleets. A variety of other applications will be apparent to a person skilled in the art.

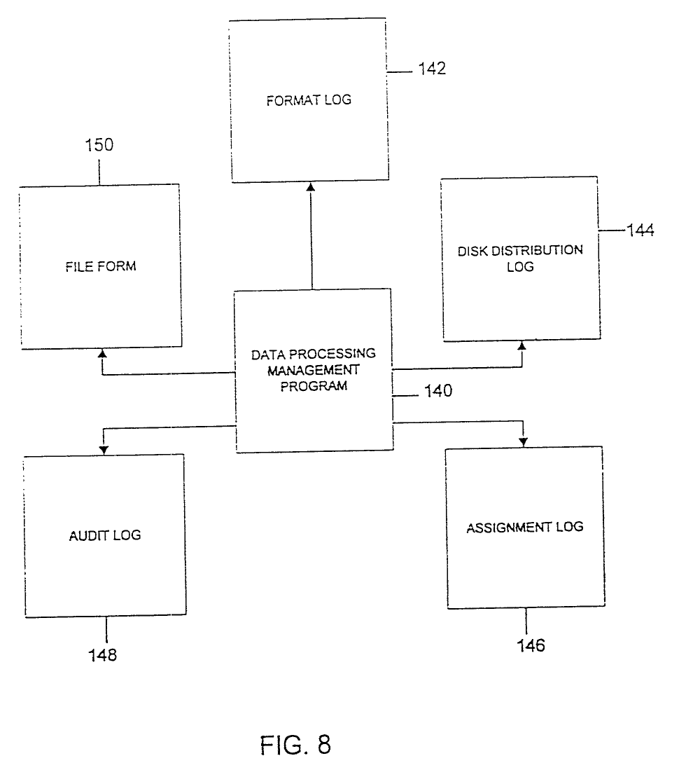

A data processing management program 140 illustrated in FIG. 8, allows management of the data. In one embodiment, a format log 142 may be generated to track the availability of disks for data collection. A format log 142 may include information about the data a disk was used, the formatting of a disk, and the status of a disk. Other information may also be included in the format log 142.

In another embodiment of the invention, a disk distribution log 144 may be generated. A disk distribution log 144 may include information about the date a disk supplied to a data handler, the name of the data handler, and the number of disks sent to that data handler. Other information may also be included in a disk distribution log 144. A disk distribution log 144 may permit better data processing management by allowing discs to be distributed more efficiently. Also, the location of disks can be tracked using the disk distribution log 144 to thereby verify the chain of custody for data used for law enforcement purposes.

Data processing and validation may also involve generating an assignment log 146. In one embodiment of the invention, an assignment log 146 may include information regarding the directory in which the data file can be found, the identification number of a file, the number of records in a file, the date the file was assigned, the date processing as finished on the file, the time taken to process the file, and any comments regarding the file. Other information, including who processed the file, statistics regarding the file processing, and the processing station number, may also be included in the assignment log 146. An assignment log 146 may allow better data processing management by tracking data processing and validation.

In another embodiment of the invention, data processing and validation may include generating an audit log 148. An audit log 148 may include information about an auditor's name, the data processor's name, the date of the audit, the number of records reviewed, the number of accurate records, the accuracy percentage, suggestions for improving accuracy, and the time to improve accuracy. Other information, including the file audited and the date the data processor completed the file may also be included in the audit log 148. An audit log 148 may permit increased accuracy of data processing and validation by providing quality control information which can be used to implement corrective measures.

Data processing and validation may also involve generating a file form 150. A file form 150 may include information regarding statistics for record processing. In one embodiment of the invention, a file form 150 may include the date processing occurred, the starting and ending record, the number of records processed, the start and end time, and the amount of time spent processing. Other information may include the name of the user and station where the processing occurred, as well as the number of records processed per hour. In one embodiment of the invention, comments may be included in a file form 150. Comments may include notes regarding the processing and/or characteristics of the images, or problems with a particular processing station. Other information may also be included in the file form 150. A file form 150 permits improved data processing by providing productivity data, preventing duplication of data processing and validation and identifying problem areas.

According to an embodiment of the invention, RSD components may be checked to ensure an RSD is properly functioning. Calibration of an RSD may occur. Other components may be checked to ensure the accuracy of an RSD. According to an embodiment of the invention, an RSD may have a light source, a mirror(s), and a sensor(s). These components may be checked to ensure they are functioning and that there is proper alignment. Checking components may comprise RSD diagnostic equipment checking components or having a person visit an RSD location and physically checking to ensure the components are functioning properly. Components to be checked may include, but are not limited to, an RSD processor, an ALR, and an RSD memory. Other components may be checked and other manners of checking RSD components may also be used.

To ensure that an RSD is functioning properly, it may be necessary to have a description of the RSD location and any significant events or activities that have occurred around or near an RSD. According to an embodiment of the invention, an RSD location description may be necessary. A location description may include the address where an RSD is located, the type of road the RSD is located on, and the surrounding physical structures. For example, an RSD may be located in an extremely enclosed area. Such an area, under certain conditions, may result in vehicle emissions accumulating. This accumulation may lead to questionable results.

According to an embodiment of the invention, significant activity near the RSD may be described. Significant events may include construction occurring on the road, painting occurring nearby, malfunctioning intersection stoplights or other events. These events may result in inaccurate data. For example, fumes from painting may interfere with detection, as may dust and dirt from construction work or fumes from construction materials. A malfunctioning stoplight may result in backed up cars and mixing emissions from various vehicles. Other activities may also effect data gathered by an RSD.

According to an embodiment of the invention, the weather and climate at the RSD location may be described. For example, a high pollen count may influence RSD data gathering. If an RSD is located, for example, in a city, high temperatures may result in ozone warnings. The high levels of ozone may effect data gathered. Other weather aspects may also influence an RSD.

According to an embodiment of the invention, an activities log may be generated to monitor and record the activities around an RSD. Activities recorded may include the description of an RSD location, whether conditions around an RSD location, and any other significant activities that occur around an RSD location.

Data processing and review may include recognizing patterns of problems and suggesting possible solutions. Data may be reviewed for accuracy, as noted above, where inaccurate data may be deleted or excluded. According to an embodiment of the invention, if a predetermined amount of data is inaccurate for a given reason, a user may be alerted. Data with a particular problem may be compiled and further analyzed. According to an embodiment of the invention, analysis may include separating data according to the RSD which gathered the data, accessing activity logs, separating data according to the data handler which processed the data, and other analysis. Suggestions for what is causing the problem may be made.

For example, a predetermined amount of data may be considered inaccurate due to low overall readings at an RSD sensor. The data may be grouped according to the RSD which gathered the data and the data handler who processed the data. It may be determined that a particular data handler has processed a large portion of the inaccurate data. The system may suggest that the data handler be retrained, or monitored more closely. It may be determined that a particular RSD has gathered a large portion of the inaccurate data. Activity logs may be consulted to determine if any significant activities occurred at the RSD location. According to the present example, it may be noted that road construction occurred near an RSD location that gathered a large portion of inaccurate data. The system may suggest that dust and fumes from the construction caused the inaccurate data. Other methods for determining problems and suggesting solutions may also be used.

According to an embodiment of the invention, the chain of custody of data from RSD's may be accounted for or maintained. For law enforcement purposes, such as for sending and enforcing citations to vehicle owners, the custody of the data must be accounted for at all times, particularly if enforcement is sought in court. According to an embodiment of the invention, an access log may be compiled for each file of records. An access log may comprise listing each person who accessed a file or record, the time of access, and the amount of time accessed. Other information may also be included in an access log. Information from a data processing management program 140 may be used in connection with an access log.

Further, as noted previously, access to files and records may limited to ensure a proper chain of custody. According to an embodiment of the invention, a user identification and password may be required to access a file or records. For example, to access a network via an internet service provider, a password or other conventional manner of security may be used. A network may compile information on when a user entered the network, and trace the steps taken by the user while in the network. Other security measures may also be used at other points in the data processing, and validation sequence. If files are sent physically, such as by magnetic or optical disk, a password may be needed to access the information. Other security may also be used.

According to an embodiment of the invention, an RSD may gather appropriate data, and encode it with password protection. The encoded data may be sent to data handlers. According to an embodiment of the invention, encoded data may be sent to a data handler while the password to the encoded data may be sent separately. Data handling, data review and plate matching may be performed on the data. Data may again be encoded if it is necessary to transfer data from one location to another. A new encoding may be used for the data, or a previous encoding may be used. Processed data may be sent to a client and may be archived. Data sent to a client may also be encoded for security. Other methods for securing data may also be used such as limiting or preventing access the certain data or achieving a copy of raw data to ensure that no unauthorized changes were made. An access log may be generated. An access log may include an RSD identifier, how the data was encoded, who had the password, and when the data was sent to various users. Other information may also be gathered.

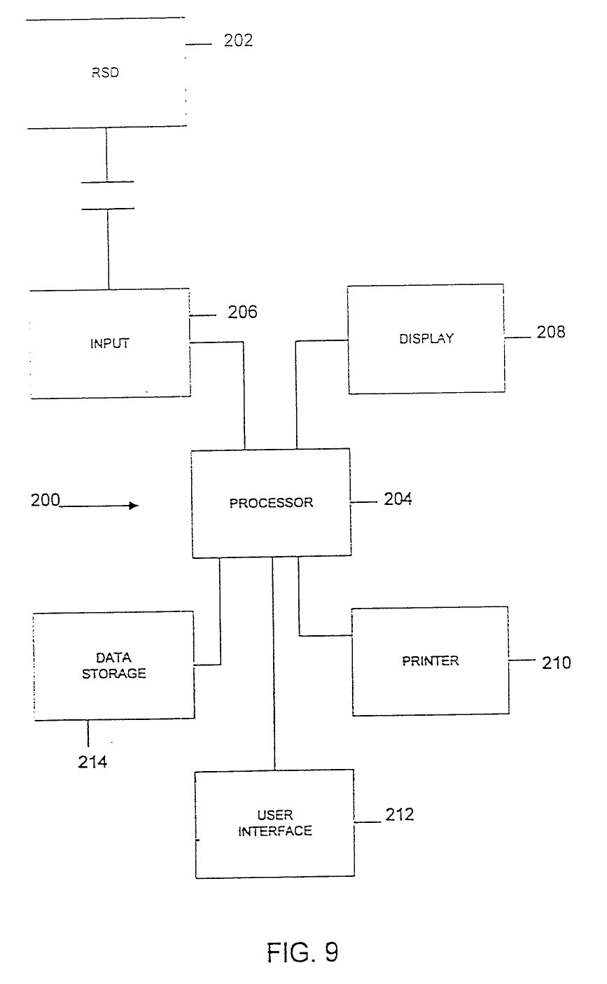

FIG. 9 illustrates a block diagram of a data processing and validation system 200 of one embodiment of the invention. RSD 202 gathers emission data, image data, license plate data, and other data. Data is sent to processor 204 through input 206. Processor 204 functions to process, handle, and direct data, as well as perform other operations involved in data processing and validation. In one embodiment of the present invention, processor 204 may comprise a standard stand alone computer processing unit (CPU). In another embodiment of the invention, a mainframe processing unit with a plurality of terminals for users may be used. Other conventional data processing may also be used.

Input 206 may be used to input data, including vehicle emissions data and vehicle images, into a processor 204. In one embodiment of the invention, input may include an optical disk reader or a magnetic disk reader for retrieving vehicle emissions data from optical storage disks or magnetic storage disks. In another embodiment of the invention, input 204 may comprise a modem to input data. In a preferred embodiment of the invention, fiber optic or coaxial wire cables, or conventional telephone wires may be employed to input data to processor 204. Other inputs 206 may also be used.

A user may process data and enter various criteria using a user interface 212. User interface 212 allows a user to interact with data processed by processor 204. Interaction may include inputting user defined criteria, and editing data. User interface 212 may include a keyboard, a touch pad, a touch screen, a light pen and/or a mouse. Other user interfaces may also be used. Data may be stored in data storage 214. Storage of data may occur at any time during the editing process. Data may be viewed by a user on display 208 such as a monitor, or by printing data on printer 210. Other means for viewing data may also be used.

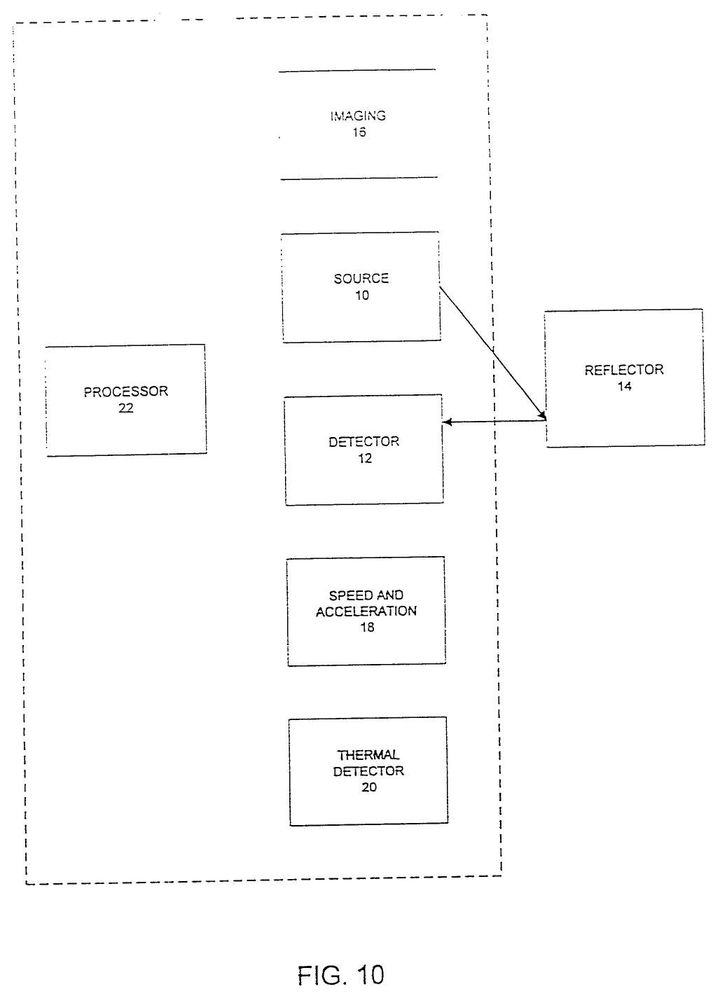

The present invention is suitable to be employed in conjunction with a remote emission sensing device. FIG. 10 illustrates a schematic representation of components of an RSD in which the present invention may be employed. Embodiments of the invention may include some or all of the various components as described below.

Radiation Source

Preferably, an RSD comprises a source of electromagnetic radiation 10 which may be used in the absorption spectroscopy measurement of various components of vehicle exhaust emissions. Preferably, source 10 may comprise an infrared (IR) radiation source. Some embodiments of the RSD may include other types of radiation sources, for example, an ultraviolet (UV) source, a visible light source, or a combination of radiation sources.

Radiation Detector

The RSD may further comprise a detector array 12 for detecting radiation. The detector array 12 is preferably chosen to permit detection of electromagnetic radiation emitted by the source 10. For example, detector array 12 may comprise a photodetector (e.g., a photodiode), a photomultiplier tube (PMT), a spectrometer or any other suitable radiation detector. For example, a mercury cadmium telluride (Hg—Cd—Te) photodetector may be used to detect IR radiation. Other suitable detectors or detector arrays 12 may also be used.

According to an embodiment of the invention, the RSD may comprise a single detector with multiple filters instead of an array employing multiple detectors. The multiple filters may be moveable, such as spinning filters, to allow multiple components to be detected. In this manner, a single detector can be employed to detect a plurality of different exhaust components because each of the moveable filters is designed to allow only the wavelength band of interest for a particular exhaust component to pass to the detector. According to another embodiment of the invention, the RSD may comprise a spectrometer, or other detecting device which may be used to detect more than one component.

Reflector

Preferably, the RSD may comprise a reflector 14 mounted in a manner to allow radiation from the source 10 to be reflected to the detector array 12 for analysis. The reflector 14 may comprise a mirror, flat mirror, lateral transfer mirror (LTM), vertical transfer mirror (VTM), reflector, or other device. In one embodiment the reflector 14 may comprise a lateral transfer mirror to reflect radiation from the source 10 along a path displaced laterally or vertically, depending on orientation, from the incident direction.

Imaging Unit

The RSD may include an imaging unit 16 to capture and/or record an image of a vehicle passing by the RSD. The imaging, unit 16 may be arranged to record an image of a vehicle at a specified location relative to the detection system. The imaging unit 16 may comprise, for example, a camera, such as a film, video or digital camera. Other imaging devices may also be used.

Preferably, the imaging unit 16 may record an image of the vehicle identification tag (i.e., license plate). Tag information may be processed, using a suitable data processor, to provide additional information about the vehicle. For example, Motor Vehicle Department databases may be accessed to retrieve owner information, make, model type, model year and other information. In some embodiments, this additional information may be incorporated into the emission sensing data analysis. For example, the make and model year of the vehicle may be used to determine input information for certain processing, steps, including information such as whether the vehicle includes a carburetor or fuel injector, whether the car runs on diesel fuel or gasoline, etc.

Speed and Acceleration

The RSD may also include a speed and accelerator detection unit 18. Preferably, a vehicle's speed and/or acceleration may be measured as it passes the RSD using speed detection unit 18. For example, the speed and acceleration detection unit 18 may comprise an arrangement of laser beams or other light beams associated with timing circuitry. According to an embodiment of the invention, the laser or light beams may be arranged to traverse the path of a vehicle at various points. As a vehicle passes, it will cause interruptions in the laser or light beams. The times at which the beam interrupts occur may be used to calculate the vehicle's speed and/or acceleration. Other methods of determining vehicle speed and/or acceleration may also be used.

According to another embodiment of the invention, the laser or light beams may be arranged to traverse the path of a vehicle at a single point in the vehicle's path. For example, radar systems may be used to determine vehicle speed and acceleration. Alternatively, transducers, piezoelectric elements, or other “drive over” detectors may be placed at locations in the roadway to monitor vehicle passage. Preferably, speed and/or acceleration data may be input into a data processing unit 22 to help characterize vehicle operating conditions (e.g., accelerating or decelerating) or to be used to determine which vehicle is to be associated with a particular sensor measurement. Other uses of the speed and acceleration data are also possible.

Thermal Detection Unit

Some embodiments of the invention may incorporate a thermal detection unit 20. Preferably, the thermal direction unit 20 may comprise a non-contact thermometer system. For example, an IR thermometer may be used to optically detect the temperature of remote objects. Other temperature detection systems may also be used.

Preferably, the thermal detection unit 20 is used to detect the temperature or portions of the vehicle passing through the RSD. Some embodiments may use direct sensing of the area of interest. For example, an IR thermometer may be aimed at the underside of a passing vehicle to detect the temperature(s) of vehicle components (e.g., engine, catalytic converter, muffler, etc.). Indirect sensing may also be used. For example, an IR thermometer may be aimed at the roadway to measure the heat of the passing vehicle which is reflected from the roadway surface.

Preferably, the thermal information recorded by the thermal detection unit 20 may be used to indicate that the engine has just recently been started (i.e., the engine is “cold” or has not reached normal operating temperature). Such a cold engine reading may be used, for example, to initiate an alternative data processing routine. Certain embodiments of the present invention may reduce the chance of a potentially misleading reading by also detecting the temperature of other portions of the vehicle. Other uses for collected thermal data are also possible.

Thermal detection unit 20 may comprise various detection apparatus configurations. For example, two thermal detectors may be arranged to detect a vehicle traveling in a traffic lane. Preferably, the two thermal detectors are positioned at points affording different angles of view at a passing vehicle. For example, the thermal detectors may be positioned near the locations of speed and acceleration detection units (i.e., spaced with some distance between detectors). Spatial separation of the thermal detectors and the differing angles of view increase the likelihood of detecting the temperature of the areas of interest on the vehicle (e.g., the engine, catalytic converted, etc.) and also afford a time sequence of measurements since the vehicle passes one detector, then the other at a later time. In some embodiments, an additional thermal detector may be incorporated into the RSD. For example, an additional thermal detector may be positioned at a suitable location to detect the temperature of the front of the vehicle (e.g., the radiator or engine). For example, a thermal detector may be positioned at either side of a traffic lane, at a sufficient height to detect the front of the vehicle, or a detector may be embedded into the lane to record a head-on view of an oncoming vehicle.

Some embodiments of the invention may include arrays of thermal detectors to increase the likelihood of obtaining the desired temperature readings. For example, in an embodiment incorporating an IR thermometer, an array of detection beams may be aimed at a vehicle. The array may span vertical and horizontal regions. Using such an array of detection beams allows the thermal detection unit 20 to detect the temperature of vehicles of varying size and shape. In addition, some of the beams in the array may be used to detect reflected heat off of the road surface of a lane.

Using an array of detector beams may also provide greater precision in temperature measurements. The focal point of each detection beam in the array can be narrowed to detect the temperature of a small region of interest. In this manner, a more precise temperature reading for each point may be obtained. For example, a detector beam with a focal point four inches in diameter will take an average temperature over the whole four inch region within the focal point. If the region of interest happens to be a one inch exhaust pipe on a vehicle, the detector will average the temperature of the region of interest (i.e., the pipe comprising one-fourth of the focal region) with objects outside of the region of interest (i.e., the other three fourths of the focal region). In contrast, an array of smaller focal point detector beams e.g., one inch in diameter each), if properly aligned, will be more likely to provide a precise temperature reading for a small region of interest.

Processing Unit

The RSD preferably includes a data processing unit 22. The data processing unit 22 may include a suitable processing device, for example, a computer or other microprocessor. The data processing unit 22 may optionally employ software to accomplish desired analysis of collected and/or stored data. Other data processing functions are also possible.

Other embodiments and uses of the invention will be apparent to those skilled in the art from consideration of the specification and practice of the invention disclosed herein. The specification and examples should be considered exemplary only.

What is claimed is:

1. A method for validating data from a remote vehicle emission sensing device, comprising the steps of:
obtaining data from at least one remote vehicle emission sensing device including at least vehicle emission data;
validating at least a part of the data by inspection of at least some of said vehicle emission data, wherein the step of validating the data comprises one or more of:
a) checking for insufficient exhaust plume,
b) checking for a calibration error,
c) checking for improper optical component alignment,
d) checking for inordinately low or high readings for one or more exhaust components,
e) checking for large variations between different readings taken for the same exhaust plume,
f) determining whether there is a second source of emissions present,
g) determining whether vehicle speed criteria are met,
h) determining whether vehicle acceleration criteria are met, and
i) determining whether ambient or local conditions have significantly influenced the data collected;
designating that the vehicle emission data either:
i) meets predetermined quality assurance criteria; or
ii) does not meet predetermined quality assurance criteria; and
providing an indication that said data has been validated.

2. The method according to claim 1, wherein the obtained data comprises vehicle identification data, and
wherein the step of validating at least part of the data comprises inspection of the vehicle identification data.

3. The method according to claim 2, wherein the vehicle identification data comprises data selected from license plate data and image data; and
wherein the step of validating further comprises determining a license plate number based on an inspection or at least some of the vehicle identification data.

4. The method according to claim 1, further comprising the steps of:
matching vehicle identification data with the appropriate vehicle emission data based on inspection of at least a portion of the vehicle identification data; and
combining the vehicle identification data and the vehicle emission data.

5. The method according to claim 1, wherein the step of validating the data comprises two or more of:
a) checking for insufficient exhaust plume,
b) checking for a calibration error,
c) checking for improper optical component alignment,
d) checking for inordinately low or high readings for one or more exhaust components,
e) checking for large variations between different readings taken for the same exhaust plume,
f) determining whether there is a second source of emissions present,
g) determining whether vehicle speed criteria are met,
h) determining whether vehicle acceleration criteria are met, and
i) determining whether ambient or local conditions have significantly influenced the data collected.

6. The method according to claim 1, wherein the step of validating the data comprises three or more of:
a) checking for insufficient exhaust plume,
b) checking for a calibration error,
c) checking for improper optical component alignment,
d) checking for inordinately low or high readings for one or more exhaust components,
e) checking for large variations between different readings taken for the same exhaust plume,
f) determining whether there is a second source of emissions present,
g) determining whether vehicle speed criteria are met,
h) determining whether vehicle acceleration criteria are met, and
i) determining whether ambient or local conditions have significantly influenced the data collected.

7. The method according to claim 1, wherein the step of validating the data comprises four or more of:
a) checking for insufficient exhaust plume,
b) checking for a calibrator error,
c) checking for improper optical component alignment,
d) checking for inordinately low or high readings for one or more exhaust components,
e) checking for large variations between different readings taken for the same exhaust plume,
f) determining whether there is a second source of emissions present,
g) determining whether vehicle speed criteria are met,
h) determining whether vehicle acceleration criteria are met, and
i) determining whether ambient or local conditions have significantly influenced the data collected.

8. The method according to claim 1, wherein the step of validating the data comprises five or more of:
a) checking for insufficient exhaust plume,
b) checking for a calibration error,
c) checking for improper optical component alignment,
d) checking for inordinately low or high readings for one or more exhaust components,
e) checking for large variations between different readings taken for the same exhaust plume,
f) determining whether there is a second source of emissions present,
g) determining whether vehicle speed criteria are met,
h) determining whether vehicle acceleration criteria are met, and
i) determining whether ambient or local conditions have significantly influenced the data collected.

9. The method according to claim 1, wherein the step of validating the data comprises six or more of:
a) checking for insufficient exhaust plume,
b) checking for a calibration error,
c) checking for improper optical component alignment,
d) checking for inordinately low or high readings for one or more exhaust components,
e) checking for large variations between different readings taken for the same exhaust plume,
f) determining whether there is a second source of emissions present,
g) determining whether vehicle speed criteria are met,
h) determining whether vehicle acceleration criteria are met, and
i) determining whether ambient or local conditions have significantly influenced the data collected.

10. The method according to claim 1, wherein the step of validating the data comprises seven or more of:
a) checking for insufficient exhaust plume,
b) checking for a calibration error,
c) checking for improper optical component alignment,
d) checking for inordinately low or high readings for one or more exhaust components,
e) checking for large variations between different readings taken for the same exhaust plume,
f) determining whether there is a second source of emissions present,
g) determining whether vehicle speed criteria are met,
h) determining whether vehicle acceleration criteria are met, and
i) determining whether ambient or local conditions have significantly influenced the data collected.

11. The method according to claim 1, further comprising the step of maintaining the chain of custody of the vehicle emission data and vehicle identification data in a manner sufficient to allow introduction of the validated data as evidence in a legal proceeding.

12. The method according to claim 1, further comprising the step of calibrating the remote vehicle emission sensing device immediately prior to obtaining the vehicle emission data.

13. The method according to claim 1, further comprising the steps of:
deleting inaccurate data;
identifying patterns of inaccurate data; and
suggesting reasons for inaccurate data.

14. A method for validating information from a remote vehicle emission sensing device comprising the steps of:
sensing emissions from a vehicle at the remote sensing device to create emissions data;
obtaining an image of a license plate of a vehicle at the remote sensing device to create image data;
combining the emissions data and image data;
forwarding the combined data to a processing station;
displaying the combined data at the processing station;
validating at least part of the combined data by inspection, wherein the step of validating comprises:
a) reviewing the vehicle emission data for reliability;
b) comparing the vehicle emission data to predetermined data ranges to ensure that the vehicle emission data meets predetermined quality assurance criteria; and
c) designating that the vehicle emission data either:
i) meets predetermined quality assurance criteria; or
ii) does not meet predetermined quality assurance criteria; and
forwarding the validated data to a data storage location.

15. The method according to claim 14, wherein the step of validating the combined data further comprises the steps of:
determining the license plate data from the image data; and
providing an indication that the combined data has been validated.

16. The method according to claim 1, wherein the step of validating the combined data comprises the step of ensuring that a minimum amount of reliable emissions data has been obtained.

17. The method according to claim 16, wherein the step of comparing the vehicle emission data to predetermined data ranges comprises checking for one or more of: insufficient exhaust plume, calibration error, improper optical component alignment, inordinately low or high readings for one or more exhaust components, large variations between different readings taken for the same exhaust plume, whether there is a second source of emissions present, whether vehicle speed criteria are met, whether vehicle acceleration criteria are met, and whether ambient or local conditions have significantly influenced the data collected.

18. A system for validating data from a remote vehicle emission sensing device, the system comprising:
a remote vehicle emission sensing device for remotely obtaining vehicle emission data from the exhaust plume of a vehicle;
means for validating at least a part of the vehicle emission data by inspection of said data, wherein validating comprises:
a) comparing the vehicle emission data to predetermined data ranges to ensure that the vehicle emission data meets predetermined quality assurance criteria; and
b) designating that the vehicle emission data either:
i) meets predetermined quality assurance criteria; or
ii) does not meet predetermined quality assurance criteria; and
means for providing an indication that said data has been validated.

19. The system according to claim 18, further comprising means for obtaining vehicle identification data, and
wherein the means for validating at least part of the data comprises a means for inspection of the vehicle identification data.

20. The system according to claim 19, wherein the vehicle identification data comprises license plate data; and
wherein the means for validating further comprises means for determining a license plate number based on the license plate data.

21. The system according to claim 18, further comprising:
means for matching vehicle identification data with the appropriate vehicle emissions data based on inspection of the vehicle identification data; and
means for combining the vehicle identification data and the vehicle emissions data.

22. The system according to claim 21, wherein:
a) the vehicle identification data comprises vehicle image data; and
b) the means for validating the data further comprises means for determining a license plate number based on the vehicle image data.

23. The system according to claim 18, further comprising:
means for obtaining image data of the same vehicle from which the vehicle emission data was obtained; and
means for combining the vehicle emission data and the image data prior to validating at least some of the data.

24. The system according to claim 18, wherein the means for validating vehicle emission data includes the means for ensuring that a minimum amount of reliable vehicle emission data has been obtained.

25. The system according to claim 24, wherein the means for ensuring that a minimum amount of reliable vehicle emission data has been obtained includes means to ensure that one or more of the following conditions is not present:
a) insufficient exhaust plume,
b) calibration error,
c) improper optical component alignment,
d) inordinately low or high readings for one or more exhaust components,
e) large variations between different readings taken for the same exhaust plume,
f) whether there is a second source of emissions present,
g) whether vehicle speed criteria are met,
h) whether vehicle acceleration criteria are met, and
i) whether ambient or local conditions have significantly influenced the data collected.

26. The system according to claim 25, further comprising means for indicating the cause of vehicle emission data being determined to be unreliable by said means for ensuring the reliability of the vehicle emissions data.

27. The system according to claim 18, wherein the vehicle identification data includes image data and license plate data obtained by an automatic license plate reader.

28. The system according to claim 27, wherein the means for validating further comprises:
a) means for comparing the license plate data and the image data;
b) means for correcting the license plate data when the image data is inconsistent with the license plate data; and
c) means for confirming that the license plate data and the image data are consistent.

29. The system according to claim 18, further comprising the means for maintaining the chain of custody of the vehicle emission data and vehicle identification data in a manner sufficient to allow introduction of the validated data as evidence in a legal proceeding.

30. The system according to claim 18, further comprising means for calibrating the remote vehicle emission sensing device prior to obtaining the vehicle emission data.

31. The system according to claim 18, further comprising:
means for deleting inaccurate data;
means for identifying patterns of inaccurate data; and
means for suggesting reasons for inaccurate data.

32. A system for processing information from a remote vehicle emission sensing device comprising:
means for obtaining an image of a license plate of a vehicle at the remote sensing device to create image data;
means for automatically reading the license plate to create license plate data;
means for combining the emissions data, image data, and license plate data;
means for forwarding the combined data to a processing station;
means for displaying the combined data at the processing station;
means for validating the combined data by inspection, wherein validating comprises:
a) comparing the vehicle emission data to predetermined data ranges to ensure that the vehicle emission data meets predetermined quality assurance criteria; and
b) designating that the vehicle emission data either:
i) meets predetermined quality assurance criteria; or
ii) does not meet predetermined quality assurance criteria; and
means for forwarding the validated data to a data storage location.

33. The system according to claim 32, wherein the means for validating the combined data further comprises:
means for comparing the license plate data and the image data;
means for correcting the license plate data when the image data is inconsistent with the license plate data;
means for confirming that the license plate data and the image data are consistent; and
means for providing an indication that the combined data has been validated.

34. The system according to claim 32, wherein the means for validating the combined data further comprises means for ensuring that a minimum amount of reliable emissions data has been obtained.
